(19) United States
(12) Patent Application Publication
(10) Pub. No.: US 2005/0273821 A1
(43) Pub. Date: Dec. 8, 2005

(54) Wireless connection system for a satellite dish and receiver

(76) Inventor: Michael R. Hundley, Portsmouth, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 10/845,974

(22) Filed: May 14, 2004

(51) Int. Cl. H04N 7/18; H04N 7/20; H04N 7/16

(52) U.S. Cl. 725/62; 725/63; 725/67; 725/68

(57) ABSTRACT

A wireless re-transmitting system and method include a remote transceiver that communicates with a transceiver located near a television. The remote transceiver is located on or near a parabolic antennae and includes an independent power source. In one embodiment, all channels present within the left-hand circular polarized signal or the right-hand circular polarized signal are transmitted to the transceiver located near the television. In a second embodiment, only desired television channel signals are transmitted from the remote transceiver to the transceiver located near the television. Thus, the remote transceiver provides either a bundled data signal including a plurality of television signals or a single data signal corresponding to a user specified channel.

There are no related patent applications.

This invention did not receive any federal research and development funding.

### BACKGROUND OF THE INVENTION

When installing a satellite television distribution system that includes a dish antenna for receiving a satellite broadcasted television signal, it is necessary to provide a coaxial cable between the dish antenna and the television for carrying the received television signal from the antenna to the television. Typically, RG-6 cabling is used to route this broadcast television signal from the antennae to the television. An RG-6 cable has an outside diameter of approximately 0.375 inches and includes a black outer insulation that is rubberized. The rubberized insulation requires an installer to drill somewhat larger holes than the outer diameter of the cable, since the rubberized exterior exhibits a high coefficient of friction when passing through a wall of a building.

Many times, these cables are secured to the exterior of a building resulting in an unsightly installation. Most homeowners do not want black cables on the exterior of their homes. Further, attaching a coaxial cable to the dwelling's exterior causes damage to the building and allows insects to egress into an exterior wall or even into the interior of the building. Standard installation devices for securing cables include oversized clips that are secured to the exterior of the dwelling. Since most dish antennae are attached to the exterior building walls, eave corners, roofs or chimneys, the cables connecting the antennae to the television create an eyesore and is aesthetically unpleasing. Further, securing the cable to the exterior of the building causes openings that can allow water to enter the building and causing damage thereto.

Another drawback to installing coaxial cable, is the installation time is usually lengthy and therefore very expensive to install. Thus, many satellite television distribution systems are too costly to install in many types of dwellings. Also many installers charge costs for fishing wires through walls, crawling through attics and crawl spaces and trenching cables. These costs add to the overall expense of installing the distribution systems. Thus, there is a heartfelt need for having a system that includes an exterior antenna and delivers wireless television signals to a receiver on a television from the exterior antennae without the need for cables connecting the satellite dish to the receiver near the television.

### BRIEF SUMMARY OF THE INVENTION

The invention generally relates to a wireless transmission method and system for receiving satellite transmissions including television signals in a parabolic dish or other antennae receiving device and wirelessly re-transmitting the signals to a receiver connected to a television set. More specifically, the invention relates to a system comprising a remote transceiver unit with an independent power source that is located on a parabolic dish and a transceiver unit located on a television set. The transceivers communicate with one another to select a signal representative of a desired television station. The transceivers transmit their control signals and desired television signal at a high frequency such that the signal can penetrate walls of buildings to provide clear television signals to an interior of a building. Typically, the transceivers transmit in the high megahertz or lower gigahertz frequency range such that the signals can easily penetrate an exterior wall of a dwelling. Preferably, the frequency range used to transmit the control signal and selected television signal is within an unregulated frequency range. It is therefore easier to install the satellite television system of the present invention than that of the prior art.

It is an object of the invention to provide a satellite television system that is easily installed and connected between a remote antenna and a television. The system negates the necessity for running signal cable between the antennae and the television.

It is another object of the invention to provide a remote transceiver with a rechargeable, independent power supply. The independent power supply includes a rechargeable energy storage device such as a battery pack. The battery pack may be recharged with a solar cell that converts solar energy into an electric current that is stored by the battery pack. The rechargeable power source may include an uninterrupted power source that automatically comes online when the power source drops below a predetermined threshold voltage.

It is a further object of the invention to include a remote transceiver that includes frequency-shifting capabilities. The remote transceiver processes the received satellite signal and frequency shifts the satellite signal into a usable bandwidth or unregulated bandwidth such as those set aside for cordless telephones or other such bandwidths.

It is an additional object of the invention to provide a remote transceiver that re-transmits an individual signal or a plurality of signals received by an exterior satellite dish antenna to an interior television.

It is another object of the invention to provide a television transceiver connected to a television for communicating with the remote transceiver. The remote transceiver is connected to the antenna for receiving television signals.

It is an object of the invention to provide a transceiver connected to a television that wirelessly transmits a control signal for varying a bias to select between a right-hand circular polarized signal and a left-hand circular polarized signal. The transceiver also receives encoded television signals from a remote transceiver.

It is another object of the invention to provide a method and system that decreases an installation time for installing a television system that receives television signals from a satellite via a dish antennae.

Further objects, features and advantages of the invention will become apparent from a consideration of the following description and the included claims when taken in connection with the previous discussion and the accompanying drawings.

### BRIEF DESCRIPTION OF THE DRAWINGS

FIG. 1 is a general diagram of a satellite broadcast distribution system in accordance with the prior art.

FIG. 2 is a general diagram of a satellite broadcast distribution system in accordance with the invention.

FIG. 3 is a block diagram of a remote transceiver unit.

FIGS. 4A-C are block diagrams showing LNBs and associated signal processing (de-multiplexing) circuitry that strips individual television channel signals from a signal comprising a plurality of television channel signals or multiplexing circuitry that combines a plurality of television channel signals into a single signal

FIG. 5 is a block diagram of a television transceiver unit.

### DETAILED DESCRIPTION OF THE INVENTION

A wireless television distribution system includes an antenna and a low noise block filter (LNB). The system comprises a first wireless transceiver comprising an independent power source and being located on an exterior of a dwelling for retransmitting a signal processed satellite television signal. A second wireless transceiver connected to a television set and in wireless communication with the first wireless transceiver. The second wireless transceiver may be connected to the television set via a coaxial cable. Alternatively, the second wireless transceiver may be wirelessly connected to the television set via a wireless communication means similar to cordless telephones. The wireless television distribution system may include a first wireless transceiver that comprises switching circuitry for varying a bias signal provided to a LNB. Signal processing circuitry may also be included in the system for stripping a single television channel signal from a signal that comprises a plurality of television signals. The independent power source may include at least one solar cell for converting solar energy into electrical energy. The first wireless transceiver may be connected to the LNB for receiving a control signal indicative of a selected television signal and transmitting the selected television signal. The second wireless transceiver transmits a control signal indicative of a selected television signal and receives a selected television signal transmitted from the first transceiver. A multiplexing circuit for combining at least two channel signals to create a third signal may be included in the system. Also, the first and second wireless transceivers might include encryption and decryption circuitry such that signals passing between each is scrambled.

In another embodiment the wireless television distribution system comprises an antenna that receives television signals. A low noise block filter (LNB) connected to the antenna filters and frequency shifts a received television signal. A first transceiver connected to the LNB receives a control signal indicative of a selected television signal and transmits the selected television signal. A second transceiver transmits the control signal indicative of a selected television signal and receives the selected television signal transmitted from the first transceiver. An independent power supply connected to the first transceiver and the LNB providing power to each. Control circuitry connected between the independent power supply and the LNB varies the amount of power supplied to the LNB. The control circuitry receives a control signal from the first transceiver. The independent power supply comprises at least one solar cell and an electrical energy storage device. The electrical energy storage device may comprise at least one battery. Multiplexing circuitry for combining at least two television signals to create a third signal comprised of the at least two television signals may be included in the system. Encryption and decryption circuitry may also be included such that signals passing between each is scrambled.

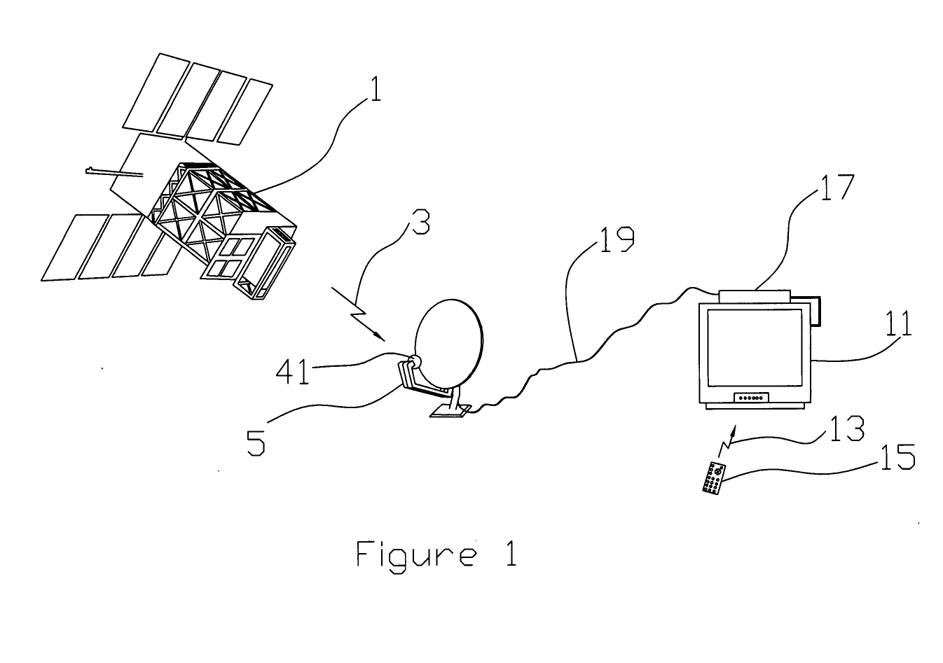

FIG. 1 illustrates the satellite television signal broadcast system according to the prior art. By way of example, the invention will be described herein as being used with a satellite-based DSS® system or other type of satellite or land-based wireless television distribution systems including C-band, KU-band, microwave, etc and including both broadband and narrowband television signals. Satellite 1 transmits a signal 3 that includes a plurality of television signals. Signal 3 is received by an antenna 5 that includes an LNB that processes the signal as mentioned above. A signal transfer cable 19, typically RG-6 is used to transmit the desired signal to the receiver 17 and to receive a control voltage signal for selecting either a left-handed or right-handed polarized signal. Thereafter, the desired polarized signal is transmitted from the antenna 5 to the receiver 17 for signal processing which strips the desired individual channel signal from the polarized signal. This signal, representing the channel to be displayed, is then routed from the receiver 17 to the television set 11. A remote 15 emits a signal 13 for controlling the receiver 17 and television 11.

Satellite television systems include satellites that broadcast channel signals to individual antennae that are mounted on buildings. Generally, the signals comprise multiple channels contained within a broadband television signal. Analog satellite systems typically operate within the C-band between 3.7 GHz and 4.2 GHz. Other satellite systems broadcast a set of signals at multiple polarizations, ie. right-hand circular polarization (RCP) and left-hand circular polarization (LCP), at 12.2 GHz and 12.7 GHz. The RCP and LCP signals include odd and even channels. Still other satellite television signal distribution systems include the Ku-band that ranges from 12 GHz and 18 GHz.

The antennae that receive these television signals include a low noise block (LNB) that filters and shifts the incoming signal to an intermediate frequency band that is between approximately 950 MHz and 2 GHz. The intermediate band signal is then transmitted through a co-axial cable to a receiver mounted on a television, as shown in FIG. 1. The receiver 17 provides a variable voltage signal that controls the polarization type of the intermediate band signal to allow different channels to be selected. For example, RCP signals are accessed by providing 13 volts D.C. to the LNB; while LCP signals are accessed by sending a 17 volt signal from the receiver to the LNB. Either the RCP or the LCP signal is routed to the receiver 17 on the television 11 for further signal processing and the desired channel is decoded and transmitted to the television 11 for display. In other types of satellite systems, a variable bias voltage may be used to select the desired channel. However, this variable bias is provided to the LNB from the receiver connected to the television set via cable.

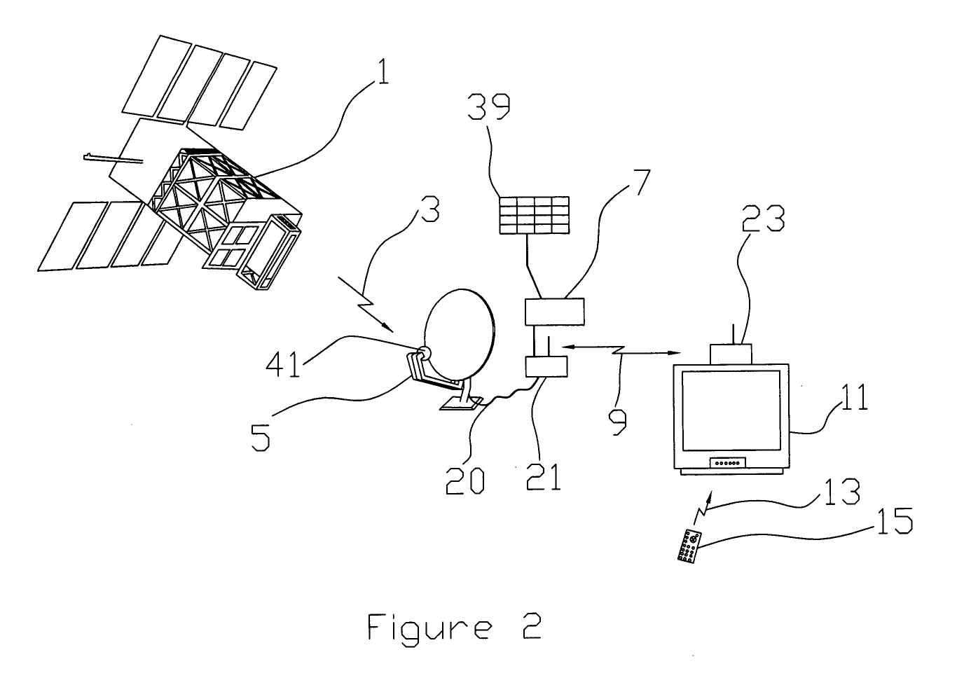

FIG. 2 depicts the satellite television signal broadcast system according to the present invention. The system includes a remote transceiver 21 including an independent power supply 7 that includes at least one solar cell 39 for converting solar energy into electrical energy that is stored in the independent power supply 7. The power supply connects to the antenna 5 and LNB 41 for providing electrical energy thereto. A signal 3 is transmitted from satellite 1 to the antenna 5 as previously mentioned. The signal 3 is received by antenna 5 which is coupled to remote transceiver 21 via coaxial cable 20. The remote power supply 7 also provides electrical power to the remote transceiver 21. The remote power supply 7 may include an uninterrupted power supply as discussed hereinafter. The remote transceiver 21 controls a bias voltage supplied from the remote power supply 7 to the LNB 41 for selecting either LCP or RCP signals. These signals are either signal processed by the remote transceiver 21 to strip a desired channel signal for display on television 11. Or, the transceiver 21 may transmit the entire LCP or RCP signal to receiver 23. That is to say, the signal 9 may comprise an entire LCP or RCP signal or a portion thereof transmitted from the transceiver 21 to transceiver 23. Signal 9 represents both the television signal and the control signals provided from transceiver 23 to transceiver 21. Transceiver 23 attaches to the television 11 for receiving a desired channel signal from the remote transceiver 21 and providing control signals thereto. The control signals are used to control transceiver 21 to vary the bias voltage for switching between the RCP and LCP signals.

In the preferred embodiment, the remote transceiver is housed in a weatherproof container. The weatherproof container includes nonconductive, non-hardening, no stick silicone gel deposited in all areas except the chip lock slots and the battery compartment. An IEEE 802.11A standard chip type transceiver set communicates between the remote transceiver and the transceiver on the television set for providing desired television signals from the remote transceiver 21 to the transceiver 23. The chip type transceiver set also communicates control signals from the transceiver 23 to the transceiver 21 to cause the bias voltage provided from the remote power source 7 to be varied to select either a RCP or LCP signal. In the preferred embodiment, a 5 GHz 802.11a chip set, manufactured by Atheros Communications in Sunnyvale, Calif., is used to provide a communications link between the transceivers. Once one of the 802.11a chips has been inserted into the slot and locked in, the installer fills the area with a hardening gel to further secure the chip and prevent unauthorized access to the internal workings of the remote transceiver. Thus, in the preferred embodiment the system includes an external transceiver housed within a weatherproofed box that includes chip lock slots and a battery compartment.

Screws for gaining access to the battery compartment comprise a special design such as a diamond shape rather than a straight or cross-tipped. These specially designed screws are tamperproof and may be removed by trained personnel only. Therefore, the screws provide an added security measure for preventing unauthorized access to the remote transceiver set.

The remote transceiver unit 21 mounts on a level surface plate. At least one solar cell 39 attaches to the remote transceiver 21 for providing a power source that recharges the power supply 7. The rechargeable power supply 7 may comprise lithium batteries or other long-life type, rechargeable batteries for powering the LNB 41, amplifiers, control circuitry and transceiver 21. The remote transceiver 21 is coupled to the receiver dish and grounded in accordance with local regulations and the National Electrical Code. The remote transceiver 21 unit may include an uninterrupted power supply (UPS) such as the type manufactured by American Power Conversion Corporation of West Kingston R.I. A comparator circuit (not shown) continuously monitors the magnitude of the voltage supplied by the rechargeable power supply 7. When the magnitude of the voltage drops below a predetermined threshold, the UPS begins supplying power to the remote transceiver unit 21.

The remote transceiver receives 21 instructions from the television set transceiver 23 that transmits a control signal 9 representative of either a RCP or LCP signal. The television set transceiver 23 receives encoded signals from the remote transceiver signal 9, processes them, and routes them to the television for displaying.

The remote transceiver 21 includes a control or switching function that causes the bias voltage supplied to the LNB 41 to vary. The switch can be implemented using transistors or other switching or amplifying logic to change or vary the voltage level provided to the LNB 41 from the independent power supply 7. Other methods of providing a variable bias circuit may include voltage divider circuits, in-line transformers or comparators that include a threshold voltage that is compared to the magnitude or frequency of a control signal to determine which signal to transmit to the transceiver on the television set 11. Alternatively, a variable output power supply may receive a control signal that causes a voltage bias level to be varied between 13 and 17 volts D.C.

In applications where multiple television sets receive a television signal from the same antenna, a pair of transmitters, or a plurality of transmitters designed to operate in a single remote transceiver unit, may be coupled to the antenna on the remote transceiver and each RCP and LCP signal is then transmitted on different frequencies. Each television set transceiver then accesses the desired signal.

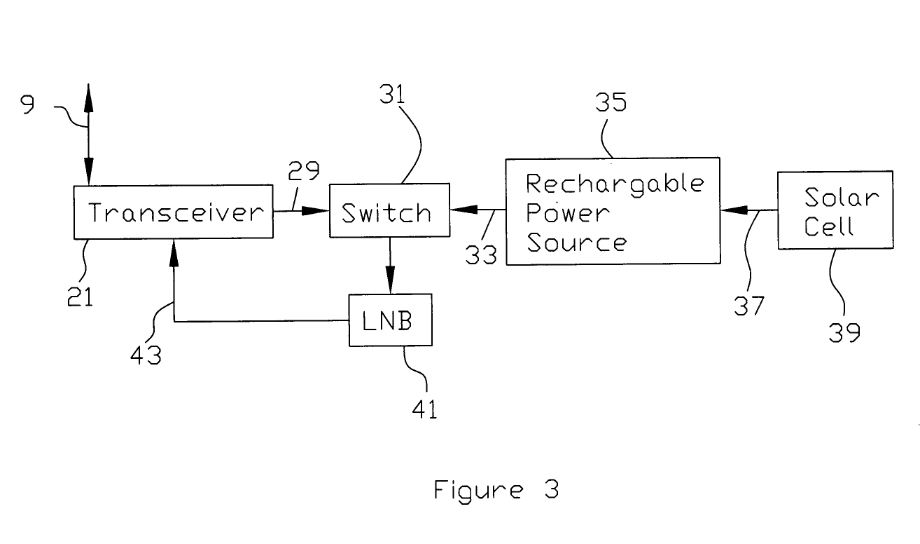

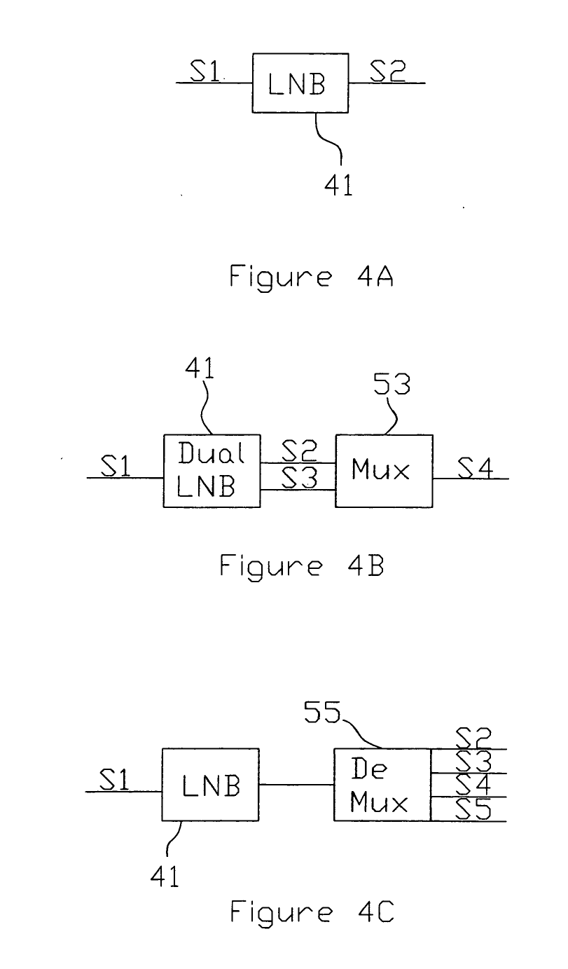

Now referring to FIGS. 3 and 4, the remote transceiver unit 21 is typically coupled to the LNB 41 via an RG-6 cable and standard coaxial connectors for receiving at least one of the RCP or LCP signals. The LNB 41 may include a single type LNB as shown in FIG. 4A. In this instance, signal S1, representative of a multi-channel television signal, enters the LNB 41 and a single signal S2, representing either the LCP or RCP signal, is stripped from S1. As previously mentioned, the bias voltage supplied to the LNB may be varied to obtain either the LCP or RCP. Alternatively, a double type or dual LNB 41 as shown in FIG. 4B may be used to capture and signal process both the LCP and RCP signals, denoted S2 and S3 in this figure. That is to say, the LNB may receive and signal process both the RCP and the LCP at the same time. In this embodiment, a single signal or multiple signals (S2 and S3) may be stripped from both the RCP and the LCP and recombined with multiplex circuitry such that a single signal S4 comprising multiple television channel signals may be transmitted from the remote transceiver unit to a single or multiple transceiver units connected to the television set(s). The receiver unit 23 may then receive the desired signal to be displayed on the television 11. In FIG. 4C, de-multiplexing circuitry strips several signals from a single signal to route them to individual transmitters that transmit the signals to multiple television set receiver systems for providing multiple television channel signals to multiple television sets as shown. The transmitter circuits may operate individually or simultaneously depending upon the selected channel for each television set receiver.

The remote transceiver unit 21 includes a transceiver for receiving a control signal transmitted from the television transceiver 23. The control signal in transceiver 21 controls a switching circuit 31 that varies the magnitude of the bias signal supplying the LNB in accordance with either the magnitude or frequency of the control signal. Power supplied from the rechargeable power source 35 varies in accordance with known power control techniques and devices to provide bias signals corresponding to a desired channel or transponder. The desired signal is signal processed in the LNB 41 and supplied to the transceiver 21 for re-transmission to the television. A solar cell 39 recharges the rechargeable power source.

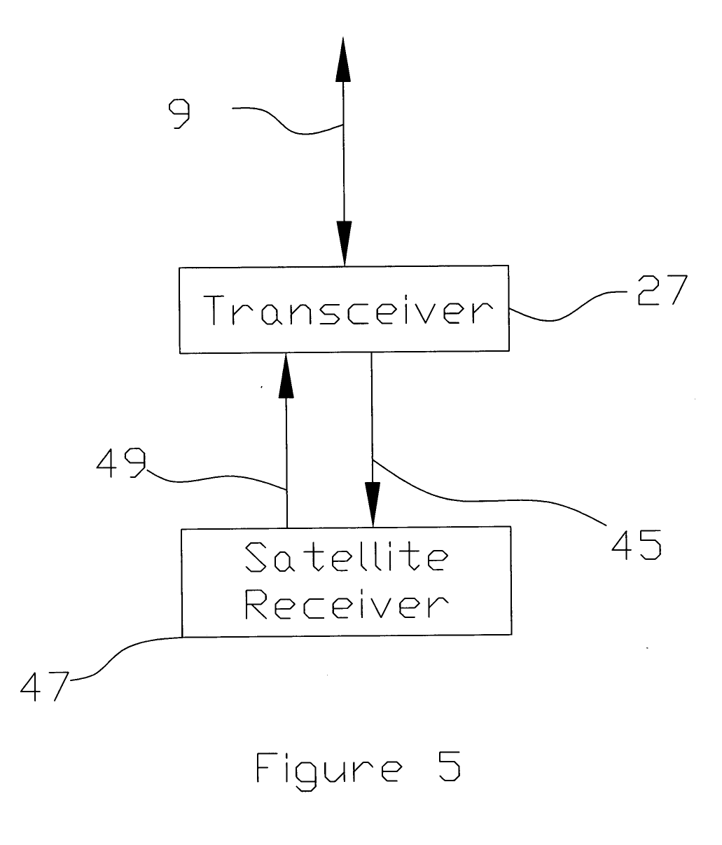

FIG. 5 depicts the operation of the television transceiver unit comprising a transceiver 27 connected to an existing satellite receiver 47. The transceiver unit includes a standard coaxial connector that mates with the “satellite in” connector on the satellite receiver for supplying a supply voltage that drives the transceiver. The voltage may be signal processed such as by a digital-to-analog converter for varying the magnitude of the output signal or may be processed to provide a unique frequency representing the magnitude of the voltage provided from the satellite receiver. Amplifiers may be included in the signal processing to generate enough power output to propagate through the exterior walls of the dwelling. Signal 49 is a control signal provided from satellite receiver 47 and indicative of a desired television channel to be displayed. Information from signal 49 is relayed to remote transceiver unit 21 via transceiver 27. Signal 9 represents both the control signals for remote transceiver unit 21 and the channel signals from the remote transceiver unit 21. The channel signal 45 is received by transceiver 27 and relayed to satellite receiver 47 for display on the television 11.

In the preferred embodiment, the transceiver 27 is powered by 13-18 volt D.C. signals provided by the satellite receiver 47. However, it is contemplated that the transceiver 27 may be powered by a standard 120 volts A.C. receptacle.

In a further embodiment, the system comprises an LNB that down converts the 12.2-12.7 GHz signal to a 5.2-5.7 GHz signal. Amplifiers powered by the rechargeable power source amplify the 5.2-5.7 GHz signal to a power level that will cause the signal to be adequately propagated throughout an interior of the dwelling. A switching circuit may be used if a single television set transceiver receives the re-transmitted satellite television signal. Otherwise, the LNB is equipped with two transmitting circuits that simultaneously transmit the RCP and the LCP signals or a multiplexer circuit that combines the two signals to create a single signal.

### Method of Operation

Operation of the installation method is now described. The installer mounts the antennae dish with the remote transceiver unit at an appropriate location near or on the exterior of the dwelling.

The LNB receives transmitted satellite television signals having a frequency range, typically, between 12.2 GHz and 12.7 GHz. These received signals are down-converted to signals having a frequency range between 0.95 GHz and 14.5 GHz. These frequency converted signals correspond to different transponders and channel selection that the customer has selected in their billing plan.

The customer selects a desired channel for viewing that corresponds to a transponder via the television set transceiver. The television set transceiver transmits a signal corresponding to the desired channel. The remote transceiver receives the signal that corresponds to the desired channel and directs a variable voltage signal to the LNB. The variable voltage signal corresponds to the desired channel. The desired channel signal is routed to the transceiver of the remote transceiver unit and re-transmitted to the television set transceiver for decoding and viewing on the television.

It should be noted that the invention may be implemented by down-converting the 12.2 GHz to 12.7 GHz signal to a desired frequency bandwidth. The signal is then amplified using operational amplifiers, transistors or other amplification means to create a signal that is strong enough to penetrate to the interior of the dwelling. This embodiment disposes of the necessity for up-converting the frequency of the satellite signal as in the previous embodiment.

The remote transceiver controls the magnitude of the direct current power flowing from the battery pack to the LNB. Thus, when the user wants to access the channels included in the LCP they enter the appropriate channel on a remote control. The receiver on the television set sends a signal to the remote transceiver located near the LNB. Control circuitry in the remote transceiver housing then switches between an input voltage signal between either 13 volts D.C. or 17 volts D.C. The desired channel signal is then stripped from the RCP or the LCP and is transmitted to the receiver on the television set to be displayed on the television.

It is to be understood that the invention is not limited to the exact construction illustrated and described above. Various changes and modifications may be made without departing from the spirit and the scope of the invention as defined in the following claims.

1. A wireless television distribution system that includes an antenna and a low noise block filter, said system comprising:
a first wireless transceiver comprising an independent power source and being located on an exterior of a dwelling for retransmitting a signal processed satellite television signal; and,
a second wireless transceiver connected to a television set and in wireless communication with the first wireless transceiver.

2. The wireless television distribution system of claim 1 wherein said second wireless transceiver is connected to the television set via a coaxial cable.

3. The wireless television distribution system of claim 1 wherein said second wireless transceiver is wirelessly connected to the television set via a wireless communication means.

4. The wireless television distribution system of claim 1 wherein said first wireless transceiver further includes switching circuitry for varying a bias signal provided to a LNB.

5. The wireless television distribution system of claim 1 further comprising signal processing circuitry for stripping a single television channel signal from a signal that comprises a plurality of television signals.

6. The wireless television distribution system of claim 1 wherein said independent power source includes at least one solar cell for converting solar energy into electrical energy.

7. The wireless television distribution system of claim 1 wherein said first wireless transceiver is connected to said LNB and for receiving a control signal indicative of a selected television signal and transmitting the selected television signal.

8. The wireless television distribution system of claim 1 wherein the second wireless transceiver transmits a control signal indicative of a selected television signal and receives a selected television signal transmitted from the first transceiver.

9. The wireless television distribution system of claim 1 further comprising a multiplexing circuit for combining at least two channel signals to create a third signal.

10. The wireless television distribution system of claim 1 wherein the first and second wireless transceivers include encryption and decryption circuitry such that signals passing between each is scrambled.

11. A wireless television distribution system comprising:
an antenna that receives television signals;
a low noise block filter (LNB) connected to said antenna and for filtering and shifting a received television signal;
a first transceiver connected to said LNB and for receiving a control signal indicative of a selected television signal and transmitting the selected television signal;
a second transceiver for transmitting the control signal indicative of a selected television signal and receiving the selected television signal transmitted from the first transceiver;
an independent power supply connected to the first transceiver and the LNB for providing power thereto; and
control circuitry connected to between the independent power supply and the LNB and for varying the amount of power supplied to the LNB, said control circuitry receiving a control signal from the first transceiver.

12. The wireless television distribution system of claim 11 wherein said independent power supply comprises at least one solar cell and an electrical energy storage device.

13. The wireless television distribution system of claim 12 wherein said electrical energy storage device comprises at least one battery.

14. The wireless television distribution system of claim 11 further comprising
multiplexing circuitry for combining at least two television signals to create a third signal comprised of the at least two television signals.

15. The wireless television distribution system of claim 11 further comprising encryption and decryption circuitry such that signals passing between each is encrypted.
